(19) United States
(12) Patent Application Publication
(10) Pub. No.: US 2025/0232140 A1
(43) Pub. Date: Jul. 17, 2025

(54) CONTENT ITEM TRANSLATION AND SEARCH

(71) Applicant: Roku, Inc., San Jose, CA (US)

(72) Inventors: Milton C. Villeda, Austin, TX (US); Ritwick Babbar, Fremont, CA (US)

(21) Appl. No.: 18/415,337

(22) Filed: Jan. 17, 2024

(51) Int. Cl. G06F 40/42; G06F 40/263

(52) U.S. Cl. CPC G06F 40/42; G06F 40/263

(57) ABSTRACT

Disclosed herein are computing system, apparatus, article of manufacture, method and/or computer program product embodiments, and/or combinations and sub-combinations thereof, for determining and utilizing sentiments of content items when translating between languages. For example, a computing system may be configured to, for a first content item, obtain text data, audio data, and video data. In some examples, the text data and audio data may be associated with a first language. Additionally, the computing system may be configured to determine a sentiment score associated with a first scene of the first content item based corresponding portions of text data, the audio data and the video data. Further, the computing system may be configured to generate a translation of the first scene based on the sentiment score. In some examples, the translation may be associated with a second language

### FIELD

This disclosure is generally directed to solutions for improving media content translations and in particular, for using sentiment analysis to improve translation accuracy.

### SUMMARY

Provided herein are computing system, apparatus, article of manufacture, method and/or computer program product embodiments, and/or combinations and sub-combinations thereof, for determining and utilizing sentiments of content items when translating between languages.

In some aspects, a computing system is provided for determining and utilizing sentiments of content items when translating between languages. The computing system may include a communications interface, a memory that stores instructions and at least one processor coupled to the communications interface and to the memory. The at least one processor may be configured to execute the instructions to, for a first content item, obtain text data, audio data, and video data. In some examples, the text data and audio data may be associated with a first language. Additionally, the at least one processor may be configured to determine a sentiment score associated with a first scene of the first content item based corresponding portions of text data, the audio data and the video data. Further, the at least one processor may be configured to generate a translation of the first scene based on the sentiment score. In some examples, the translation may be associated with a second language.

In other aspects, a method is provided for determining and utilizing sentiments of content items when translating between languages. The method may include, for a first content item, obtaining text data, audio data, and video data. In some examples, the text data and audio data may be associated with a first language. Additionally, the method may include determining a sentiment score associated with a first scene of the first content item based corresponding portions of text data, the audio data and the video data. Further, the method may include generating a translation of the first scene based on the sentiment score. In some examples, the translation may be associated with a second language.

In various aspects, a non-transitory computer-readable medium is provided for determining and utilizing sentiments of content items when translating between languages. The non-transitory computer-readable medium may store instructions that, when executed by at least one processor, cause the at least one processor to perform operations comprising for a first content item, obtaining text data, audio data, and video data. In some examples, the text data and audio data may be associated with a first language. Additionally, the operations may include determining a sentiment score associated with a first scene of the first content item based corresponding portions of text data, the audio data and the video data. Further, the operations may include generating a translation of the first scene based on the sentiment score. In some examples, the translation may be associated with a second language.

### BRIEF DESCRIPTION OF THE FIGURES

The accompanying drawings are incorporated herein and form a part of the specification.

FIG. 1 illustrates a block diagram of a multimedia environment, according to some examples of the present disclosure;

FIG. 2 illustrates a block diagram of a streaming media device, according to some examples of the present disclosure;

FIG. 3 illustrates a diagram of a portion of the multimedia environment, according to some examples of the present disclosure;

FIG. 4 illustrates a block diagram for translating a content item utilizing sentiments of the content item and one or more machine learning processes, according to some examples of the present disclosure;

FIG. 5 illustrates a diagram of a portion of the multimedia environment, according to some examples of the present disclosure;

FIG. 6 illustrates a flow chart of an example process for translating a content item utilizing sentiments of the content item, according to some examples of the present disclosure;

FIG. 7 illustrates a flow chart of an example process for querying text data and translated text data of multiple content items, according to some examples of the present disclosure;

FIG. 8 illustrates a flow chart of an example process for translating text data of multiple content items utilizing sentiments of the multiple content items and querying the translated text data and text data of each of the multiple content items, according to some examples of the present disclosure;

FIG. 9 is a diagram illustrating an example of a neural network architecture, according to some examples of the present disclosure; and

FIG. 10 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for determining and utilizing one or more sentiments of content items for translating the content items from one language to another. Additionally, the system, apparatus, device, method and/or computer program product embodiments, and/or combinations and sub-combinations provided herein are for indexing the content items based on text data of the content items, such as subtitles or closed captions, and/or translations of the text data.

Multimedia content items, such as movies, television shows, and podcasts, may include text data (e.g., closed captioning and/or subtitles), audio data (e.g., music and character dialogues) and/or video data. The text and/or audio data of the content items, may be translated from one language (e.g., English) to another language (e.g., Mandarin). However, literal or direct translations often fail to capture important contextual nuances that would otherwise be apparent to a native language consumer of the original content item. As a result, direct/literal translations may not only fail to preserve the original meaning, but in some instances can result in nonsensical or unintended outcomes. For example, in the television show “Friends,” the character Chandler Bing, is known for his frequent use of sarcasm, which is signified by his use of a sarcastic tone. One of the lines that was said in a sarcastic tone included “nice camouflage—for a minute, I almost didn't see you.” A simple literal translation from English to Mandarin would plainly read as if Chandler were complementing the other character's effective use of camouflage, which is opposite the intended meaning i.e., that the camouflage was clearly and/or humorously ineffective.

Additionally, with the growing number of available content items, it is becoming more difficult for users to decide what to watch next. In many databases, content items are indexed by title and/or metadata tags indicating corresponding genres. However, such indexing may be inadequate for returning high-relevance search results when users submit queries related to content descriptions, e.g. that lack title and/or genre information. For example, a movie database indexed by title and metadata genre tags may be unable to return interesting results for a user query such as “let's go to Paris,” for example, which may indicate user interest in content related to a specific location (e.g., Paris or France), or a particular activity (e.g., European travel, or French tourism, etc.).

Aspects of the disclosed technology address the foregoing problems by providing solutions for determining and utilizing sentiments of content items when translating between languages. In some approaches, the sentiments may be determined from text data, such as closed captioning or subtitles, audio data, and/or video data included in the content item. Additionally, the text data and/or portions of the audio data, such as portions of audio data associated with dialogue included in the content items, may be translated. Further, the determined sentiments may be incorporated with the translated content item. In some instances, the translated content items may include translated text data, such as translated closed captioning or subtitles. Additionally, or alternatively, the translated content items may include translated portions of the audio data, such as translation of the content item and/or translated portions of the audio data.

For example, a translation computing system may obtain a content item, such as an episode of the television show “Friends,” that includes text data, audio data and video data. Additionally, for a scene in which Chandler says “I'm glad we're having a rehearsal dinner . . . I rarely practice my meals before I eat,” the translation computing system may determine a sentiment or a sentiment score corresponding to the scene, e.g., based on corresponding portions of text data, audio data and/or video data. In such example, the sentiment or the sentiment score of the line is sarcastic or has a sarcastic tone. As such, the translation computing system may incorporate the determined sentiment or sentiment score with the translated content item. That way, when the translated content item is outputted on a client device, such as a dubbed audio output or as closed captioning/subtitles, the sarcastic tone of the line “I'm glad we're having a rehearsal dinner . . . I rarely practice my meals before I eat” is retained and not lost.

Additionally, aspects of the disclosed technology provide solutions for indexing the content items based on associated text data, such as subtitles or closed captions, and/or translations of the text data. In some examples, a search engine may utilize the indexed text data of content items and/or translated text data of content items to identify one or more content items related to a user submitted query. As described herein, the translated text data may be generated by the translation computing system and may be based on sentiments of a corresponding content item. By way of example, a search engine may receive a query from a user that includes the terms “let's go to Paris.” Additionally, the search engine may search text data and/or translated text data of multiple content items to identify one or more of the multiple content items that may be related to the query. Further, the search engine may return results to the user that identifies the one or more identified content items

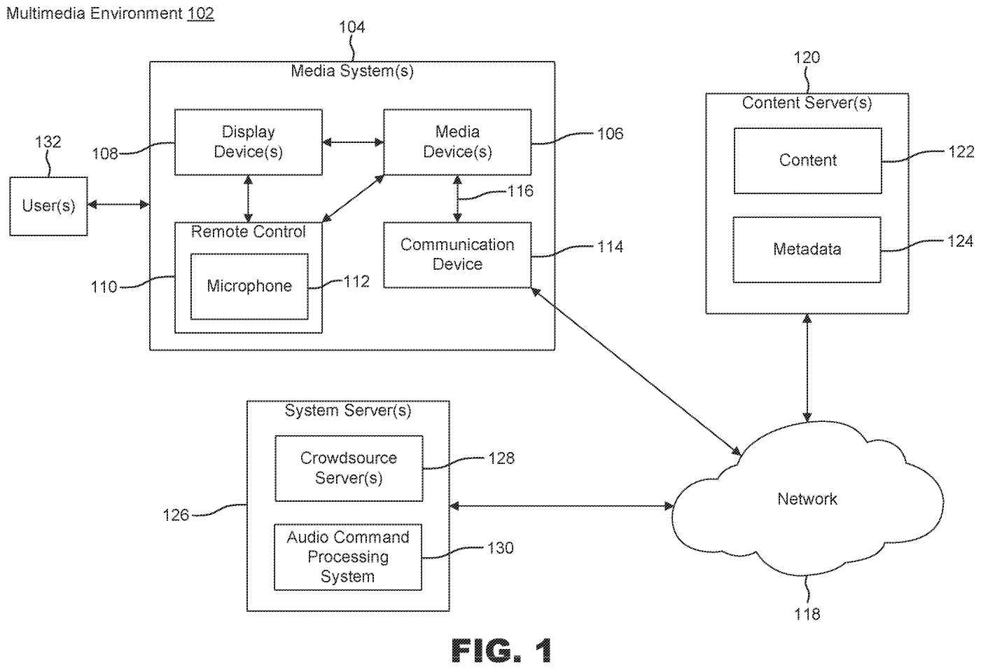

Various embodiments and aspects of this disclosure may be implemented using and/or may be part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as Wi-Fi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining to or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

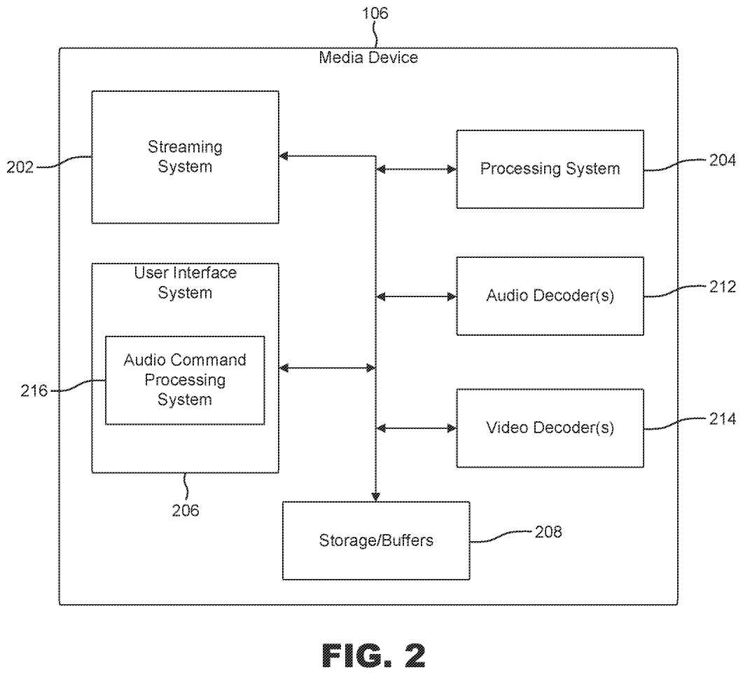

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, VVC, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, VVC, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

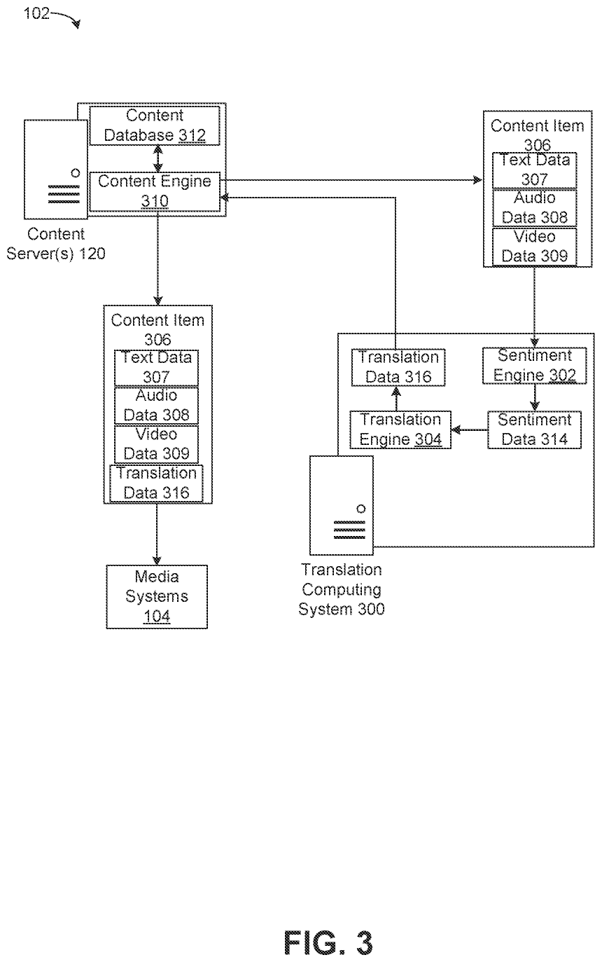

Referring to FIG. 3, multimedia environment 102 may include additional computing systems, such as translation computing system 300. As described herein, translation computing system 300 may translate content or content items, such as movies, television shows, podcasts, or any multimedia content or content item from one language to another language. Additionally, translation computing system 300 may determine one or more sentiment scores from the content and utilize the determined sentiment scores when translating the content. That way, the translated content does not lose any of the context or sentiment that was originally included in the content. As described herein, a sentiment score may correlate with a sentiment, such as a tone or emotion.

As illustrated in FIG. 3, translation computing system 300 may include sentiment engine 302 and translation engine 304. Additionally, sentiment engine 302 and translation engine 304, when executed by one or more processors of translation computing system 300, may perform any of the example processes described herein to determine the sentiment scores from one or more content items and utilizing the determined sentiment scores when translating the content items. In some examples, executed sentiment engine 302 may obtain from content server 120, content item 306 including text data 307, audio data 308 and/or video data 309. In some instances, content server(s) 120 may include content engine 310 and content database 312. Additionally, content database 212 may store content or content items, such as content item 306, and each content or content item stored in content database 312 may include text data, audio data, and/or video data, such as text data 307, audio data 308 and/or video data 309. In such instances, one or more processors of content server(s) 120 may execute content engine 310 and executed content engine 310 may perform any of the example processes described herein to obtain the content items, such as content item 306, from content database 312 and transmit the content items to translation computing system 300.

Additionally, executed sentiment engine 302 may determine the sentiment scores for the content items based on corresponding text data, audio data and/or video data. For example, executed sentiment engine 302 may determine the sentiment scores for content item 306 based on text data 307, audio data 308 and/or video data 309. In some instances, each content item, such as content item 306, may include multiple scenes. In such instances, sentiment engine 302 may determine sentiment scores for each of the multiple scenes based on corresponding portions of text data, audio data and/or video data, such as text data 307, audio data 308 and/or video data 309. In other instances, each content item, such as content item 306, may include multiple scenes and each scene may include dialogue associated with one or more characters. In such instances, one or more dialogue lines may be attributed or associated with each character. Additionally, executed sentiment engine 202 may determine a sentiment score for each dialogue line based on corresponding portions of text data, audio data and/or video data, such as text data 307, audio data 308 and/or video data 309. Further, executed sentiment engine 302 may generate sentiment data 314 based on the determined sentiment scores. Sentiment data 314 may identify and characterize the sentiment scores and/or corresponding sentiments. In some instances, sentiment data 314 may indicate the portion of content item, such as content item 306, the sentiment score is associated with or corresponds to. For instance, sentiment data 314 may indicate that a sentiment score May correspond to a particular dialogue line of a particular scene. In another instance, sentiment data 314 may indicate that a sentiment score may correspond to a particular scene.

By way of example, content item 306 may be a television episode of “Friends.” Additionally, content item 306 may include a scene including dialogue line of the character Chandler Bing “I'm glad we're having a rehearsal dinner . . . I rarely practice my meals before I eat” is retained and not lost.” Based at least on portions of text data 307, audio data 308 and/or video data 309 corresponding to the dialogue line, executed sentiment engine 302 may determine a sentiment score associated with the dialogue line. In such an example, the sentiment score may be associated with the sentiment of sarcasm or a sarcastic tone.

Moreover, executed sentiment engine 302 may transmit or provide sentiment data 314 to executed translation engine 304. In some instances, executed sentiment engine 302 may transmit or provide one or more portions of content item 306, such as text data 307 and/or audio data 308, associated with sentiment data 314. Executed translation engine 304 may generate a translation of the one or more portions of content item 306 from one language to another, based on sentiment data 314. Additionally, executed translation engine 304 may generate translation data 316 that includes the translation of the portions of content item 306. In various instances, the translation may be a translation of corresponding portions of text data 307. Additionally, or alternatively, the translation may be a translation of corresponding portions of audio data 308. As described herein, the translated portions of content item 306 may retain the context or sentiment that was originally included in content item 306.

Following the example above, executed sentiment engine 302 may generate sentiment data 314 that includes the sentiment score for the dialogue line “I'm glad we're having a rehearsal dinner . . . I rarely practice my meals before I eat.” Additionally, executed sentiment engine 302 may provide sentiment data 314 to executed translation engine 304. Moreover, executed sentiment engine 302 may provide portions of text data 307 and/or audio data 308 corresponding to the dialogue line to executed translation engine 304. Executed translation engine 304 may generate a translation of the corresponding portion of text data 307 and/or audio data 308 from a first language to a second language utilizing sentiment data 314. In some instances, the translation may be a translation of a portion of text data 307 corresponding to the dialogue line “I'm glad we're having a rehearsal dinner . . . I rarely practice my meals before I eat.” Additionally, or alternatively, the translation may be a translation of a portion of audio data 308 corresponding to the dialogue line “I'm glad we're having a rehearsal dinner . . . I rarely practice my meals before I eat.” Further, executed translation engine 304 may generate translation data 316 that includes the translation of the corresponding portion of text data 307 and/or audio data 308 from a first language to a second language, along with one or more portions of sentiment data 314. As described herein, the one or more portions of sentiment data 314 may identify the sentiment score corresponding to the dialogue line and/or indicate the sentiment corresponding to the sentiment score. For instance, the sentiment score or the corresponding sentiment may indicate the dialogue line is associated with sarcasm or a sarcastic tone.

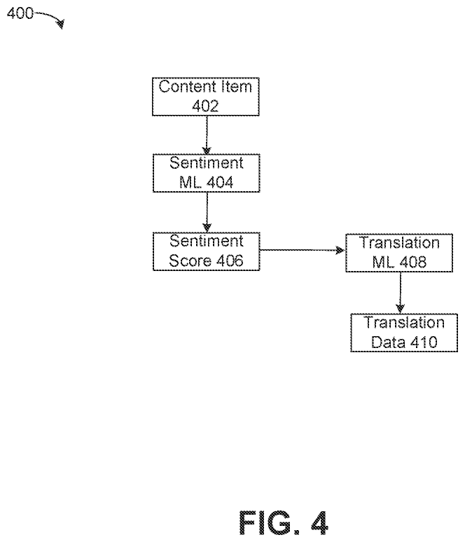

In other examples, executed sentiment engine 302 may utilize one or more trained artificial intelligence or machine learning (AI/ML) processes to determine sentiment scores of content items, such as one or more trained AI/ML processes associated with sentiment analysis. Additionally, executed translation engine 304 may utilize one or more trained AI/ML processes to translate the content items from one language to another utilizing the sentiment scores of the content items, such as one or more trained AI/ML processes associated with translating text data or audio data from one language to another. Referring to FIG. 4, computing environment 400 may include sentiment AI/ML process 404 and translation AI/ML process 408. Additionally, sentiment AI/ML process 404 may be a trained AI/ML process associated with sentiment analysis, and translation AI/ML process 408 may be a trained AI/ML process associated with translating text data or audio data from one language to another. In some instances, and as illustrated in FIG. 3 and FIG. 4, sentiment AI/ML process 404 and translation AI/ML process 408 may each be performed by separate computer programs, i.e., one or more software modules or engines, such as executed sentiment engine 302 and executed translation engine 304. In various instances, sentiment AI/ML process 404 and translation AI/ML process 408 or the functionalities of sentiment AI/ML process 404 and translation AI/ML process 408 may be performed by a single software module or engine.

As illustrated in FIG. 4, sentiment AI/ML process 404 may receive content item 306. Additionally, sentiment AI/ML process 404 may determine, for each scene or each dialogue line of each scene, a sentiment value for each corresponding portion of text data 307, audio data 308 and/or video data 309. Further, sentiment AI/ML process 404 may determine sentiment score 406 for each scene or each dialogue line of each scene based on sentiment values of the corresponding portion of text data 307, audio data 308 and/or video data 309.

In some instances, sentiment AI/ML process 404 may perform sentiment analysis on the corresponding portion of text data 307 to determine a sentiment value associated with the corresponding portion of text data 307. As described herein, the sentiment value of the corresponding portion of text data 307 (e.g., the combination of words included in the portion) may correlate with a sentiment, such as a tone or emotion, associated with the corresponding portion of text data 307.

In other instances, sentiment AI/ML process 404 may determine a sentiment value associated with the corresponding portion of audio data 308. As described herein, the sentiment value of the corresponding portion of audio data 308 may correlate with a sentiment, such as a tone or emotion, associated with the corresponding portion of audio data 308. In various instances, the corresponding portion of audio data 308 may include music, such as background music. In such instances, sentiment AI/ML process 404 may perform music analysis on the music to determine a sentiment value associated with the music. For instance, for uplifting music, sentiment AI/ML process 404 may determine a sentiment value associated with a positive or happy sentiment. In another instance, for gloomy music, sentiment AI/ML process 404 may determine a sentiment value associated with a negative, sad, or gloomy sentiment. In some instances, the corresponding portion of audio data 308 may be associated with a dialogue line of a character. In such instances, sentiment AI/ML process 404 may perform waveform analysis on the corresponding portion of audio data 308 to determine a sentiment value associated with the dialogue line of the character. For instance, for a waveform with an upward trajectory, sentiment AI/ML process 404 may determine a sentiment value associated with a positive or happy sentiment. In another instance, for a waveform with a downward trajectory, sentiment AI/ML process 404 may determine a sentiment value associated with a negative or sad sentiment.

In various instances, sentiment AI/ML process 404 may perform video analysis on the corresponding portion of video data 309 to determine a sentiment value associated with the corresponding portion of video data 309. As described herein, the sentiment value of the corresponding portion of video data 309 may correlate with a sentiment, such as a tone or emotion, associated with the corresponding portion of video data 309. In such instances, the video analysis may include analyzing one or more visual parameters of the corresponding portion of video data 309, such as the colors, the combination of objects included in the scene, etc. For instance, a scene of the corresponding portion of video data 309 may be a cemetery, and the colors of the scene may be dark and muted cool colors, such as blue, green, brown and/or beige. In such instance, sentiment AI/ML process 404 may determine a sentiment value associated with a negative, sad, or gloomy sentiment. In another instance, a scene of the corresponding portion of video data 309 may be an apartment, and the colors of the scene may be bright vibrant colors, such as yellow, orange, pink and red, or pastels, like peach, light pink and/or lilac. In such instance, sentiment AI/ML process 404 may determine a sentiment value associated with a positive or happy sentiment.

Additionally, translation AI/ML process 408 may receive sentiment score 406 from sentiment AI/ML process 404. Moreover, translation AI/ML process 408 may receive one or more portions of content item 306, such as the corresponding portion of text data 307 and/or audio data 308. In instances where executed sentiment engine 302 utilizes sentiment AI/ML process 404 and executed translation engine 304 utilizes translation AI/ML process 408, translation AI/ML process 408 may obtain the sentiment score 406 via sentiment data 314 and the one or more portions of content item 306 (e.g., corresponding portions of text data and/or audio data 308) from executed sentiment engine 302.

Further, translation AI/ML process 408 may perform a translation of the corresponding portion of text data 307 and/or audio data 308 from one language to another utilizing the corresponding sentiment score 406. For instance, the corresponding portion of text data 307 may be in English. Additionally, translation AI/ML process 408 may translate the corresponding portion of text data 307 into Malay. Further, translation AI/ML process 408 may generate translation data 316 that includes the translated corresponding portion of text data 307 along with data indicating a sentiment associated with sentiment score 406 or sentiment score 406. In another instance, the corresponding portion of audio data 308 may be in English. Additionally, translation AI/ML process 408 may translate the corresponding portion of audio data 308 into Korean. Further, translation AI/ML process 408 may generate translation data 316 that includes the translated corresponding portion of audio data 308 along with data indicating a sentiment associated with sentiment score 406 or sentiment score 406. As described herein, the data indicating the sentiment associated with sentiment score 406 or sentiment score 406 may help retain the original content or sentiment that was originally included in content item 306.

Referring back to FIG. 2, executed translation engine 204 may provide or transmit translation data 316 to content server(s) 120. Additionally, content server(s) 120 may store translation data 316. For example, and as illustrated with FIG. 2, executed content engine 210 may receive translation data 316 and store translation data 316 within content database 312. Moreover, users 132 of media systems 104 may have access to the translation of content item 306 when consuming content item 306. Further, based on the corresponding data indicating a sentiment associated with sentiment score 406 or sentiment score 406, media systems 104 may present or output the translation in light of the sentiment.

For example, based on a request for content item 306, executed content engine 210 may transmit content item 306 that includes translation data 316 along with text data 307, audio data 308 and/or video data 309 to media system 104. Additionally, translation data 316 may include translated text data 307, such as French subtitles, along with corresponding data indicating a sentiment associated with sentiment score or sentiment score. Based on translated text data 307, media system 104 may output translated text data 307. Based on the data indicating the sentiment associated with sentiment score or the sentiment score, media system 104 may output translated text data 307 with the sentiment. For instance, for the translated portion of text data 307 with corresponding sentiment score associated with sarcasm, media system 104 may present the portion of text data 307 in quotations.

In another example, translation data 316 may include translated audio data 308, such as a French audio translation, along with corresponding data indicating a sentiment associated with sentiment score or sentiment score. Based on the translated audio data 308, media system 104 may output translated audio data 308. Based on the data indicating the sentiment associated with sentiment score or the sentiment score, media system 104 may output translated audio data 308 with the sentiment. For instance, for the translated portion of audio data 308 with corresponding sentiment score associated with sarcasm, media system 104 may output the translated dialogue line that sounds sarcastic.

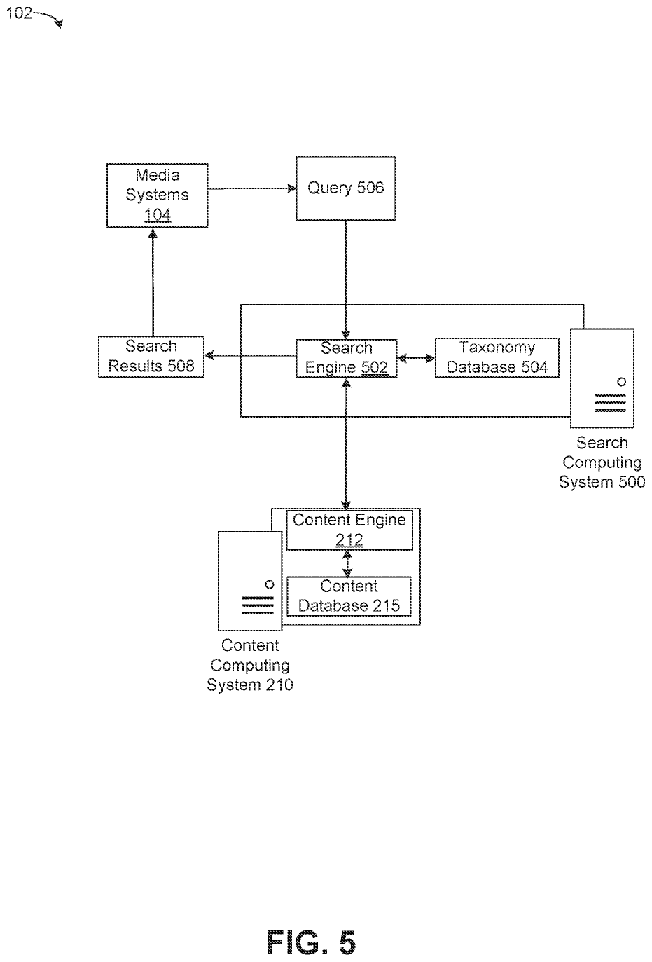

Referring to FIG. 5, multimedia environment 102 may include additional computing systems, such as search computing system 500. Additionally, search computing system 500 may access an index of content items to identify one or more content items related to a user submitted query. As described herein, the index of the content items may be based on text data (e.g., closed captioning or subtitles) and/or translated text data of the content items.

In some examples, as illustrated in FIG. 5, search computing system 500 may include search engine 502. Additionally, one or more processors of search computing system 500 may execute search engine 502 to perform any of the example processes described herein to utilize the index of content items to identify content items related to the user submitted query, such as query 506. For example, executed search engine 502 may receive query 506 from media systems 104. As described herein, query 506 may be based on one or more user inputs provided by user 132. For instance, and referring to FIG. 2, user 132 may provide the user inputs to remote control 110 (e.g., via microphone 112), and remote control 110 may generate query 506 based on the user inputs of user 132. In some instances, query 506 may include one or more terms, such as “let's go to Paris.”

Additionally, executed search engine 502 may access content database 312 and search the index of content items stored in content database 312, via executed content engine 310. Moreover, executed search engine 502 may identify one or more content items related to query 506 based on the search. Further, executed search engine 502 may generate search results 508 based on the identified one or more content items. Search results 508 may identify the one or more identified content items. In some instances, executed search engine 502 may return search results 508 to media systems 104.

By way of example, executed search engine 502 may receive query 506 from media systems 104. In such example, query 506 may include the phrase “let's go to Paris.” Additionally, executed search engine 502 may access an index of content items stored in content database 312, via executed content engine 310. As described herein, the index of content items may be based on text data and/or translated text data of the content items, such as text data 307 and translation data 316 of FIG. 3. Moreover, executed search engine 502 may search the index to identify one or more content items stored in content database 312 related to the phrase “let's go to Paris.”

In some instances, search results 508 may identify, for each identified content item, one or more classifications, such as genre (e.g., documentary, horror, thriller, drama, action, comedy, historical, animation, fantasy, etc.), type of media, etc. In such instances, executed search engine 502 may access content database 312, via content engine 310, to obtain, for each identified content item, data identifying the associated classifications. Further, executed search engine 502 may include such data into search results 508. Additionally, or alternatively, search results 508 may identify, for each identified content item, portions or segments of the content item that are associated with query 506, such as the terms, phrases or words included in query 506. For instance, query 506 may include the phrase “Muriel Bing.” Additionally, executed search engine 502 may identify a first content item, such as episode 5 of season 8 of “Friends,” as related to query 506 (e.g., the first content item may include the one or more portions of the phrase “Muriel Bing”) and may include the first content item in search results 508. Further, search results 508 may identify, for the first content item, segments or portions that include the phrase “Muriel Bing.” In some instances, executed search engine 502 may access content database 312, via content engine 310, to obtain, for each identified content item, data identifying portions or segments of the identified content item related to query 506.

In other examples, executed search engine 502 may determine whether the language associated with query 506 is the same as the text data or translated text data executed search engine 502 is searching. In such examples, query 506 may include data indicating a language associated with user 132. For instance, the language may be a preferred language of user 132 and may be obtained from account data or information of user 132. Additionally, executed search engine 502 may compare the language associated with query 506 (e.g., data indicating a language associated with user 132) with the languages associated with the text data or translated data. Based on the comparison, executed search engine 502 may determine whether to perform example processes as described herein to translate query 506 to the language associated with the text data or translated text data.

In some instances, query 506 may include data indicating that the associated language is a first language, while text data or the translated text data of a content item executed search engine 502 may be searching, may be associated with the same language as the first language. In such instances, executed search engine 502 may compare the first language to the language associated with the text data and the translated text data. Additionally, executed search engine 502 may search text data or translated text data based on whether the first language is the same as the language associated with the text data or the first language is the same as the language associated with the translated text data.

For example, one or more portions of the closed captioning included in text data of a content item (e.g., text data 307 of content item 306 of FIG. 3) may be associated with the English language and may include the term “Paris” in English. Additionally, or alternatively, one or more portions of translated subtitles included in corresponding translation data (e.g., translation data 316 of content item 306 of FIG. 3), may be associated with Mandarin and may include the term “Paris” in Mandarin. Additionally, query 506 may include the phrase or terms “let's go to Paris,” and may be associated with English. Moreover, executed search engine 502 may compare the language associated with the query against the languages associated with one or more portions of translated subtitles or the one or more portions of the closed captioning. Based on the comparison, executed search engine 502 may determine the language of query 506 is the same as the closed captioning. Further, executed search engine 502 may search the portions of the closed captioning to determine whether the portions of the closed captioning includes the one or more portions of translated query 506, such as the term “Paris.”

In an alternative example, one or more portions of the closed captioning included in text data of a content item (e.g., text data 307 of content item 306 of FIG. 3) may be associated with the English language and may include the term “Paris” in English. Additionally, or alternatively, one or more portions of translated subtitles included in corresponding translation data (e.g., translation data 316 of content item 306 of FIG. 3), may be associated with Mandarin and may include the term “Paris” in Malay. Additionally, query 506 may include the phrase or terms “let's go to Paris,” and may be associated with Malay. Moreover, executed search engine 502 may compare the language associated with the query against the languages associated with one or more portions of translated subtitles or the one or more portions of the closed captioning. Based on the comparison, executed search engine 502 may determine the language of query 506 is the same as the translated subtitles. Further, executed search engine 502 may search the portions of the translated subtitles to determine whether the portions of the translated subtitles includes the one or more portions of translated query 506, such as the term “Paris.”

In other instances, query 506 may include data indicating that the associated language is a first language, while text data and/or the translated text data of a content item executed search engine 502 may be searching, are associated with languages different from the first language. In such instances, executed search engine 502 may translate query 506 to a language associated with the text data or translated text data. Additionally, executed search engine 502 may generate search results 508 identifying the one or more content items in the language associated with the language associated with the translated query 506. Executed search engine 502 may translate the search results 508 identifying the one or more content items back to the first language. As described herein, the translated text data may be generated by translation computing system 300. Additionally, translation computing system 300 may perform any of the example processes described herein to generate the translated text data. In some instances, translation computing system 300 may determine and utilize sentiments associated with the content items to generate the translated text data (e.g., translated text data of translation data 316).

By way of example, one or more portions of the closed captioning included in text data of a content item (e.g., text data 307 of content item 306 of FIG. 3) may be associated with the English language and may include the term “Paris” in English. Additionally, or alternatively, one or more portions of translated subtitles included in corresponding translation data (e.g., translation data 316 of content item 306 of FIG. 3), may be associated with Mandarin and may include the term “Paris” in Mandarin. Additionally, query 506 may include the phrase or terms “let's go to Paris,” and may be associated with Spanish. Moreover, executed search engine 502 may compare the language associated with the query against the languages associated with one or more portions of translated subtitles or the one or more portions of the closed captioning. Based on the comparison, executed search engine 502 may determine the languages of query 506, the portions of translated subtitles and the portions of the closed captioning are different. Further, executed search engine 502 may translate query 506 into either the language associated with the portions of translated subtitles or the portions of the closed captioning. In instances where executed search engine 502 translates query 506 into the language associated with the portions of the translated subtitles, executed search engine 502 search the portions of the translated subtitles to determine whether the portions of the translated subtitles includes the one or more portions of translated query 506, such as the translated term “Paris.”

In various examples, executed search engine 502 may utilize taxonomy data stored in taxonomy database 504 to expand the search capabilities of executed search engine 502. As described herein, taxonomy data may identify a vocabulary of terms or words grouped into categories and subcategories. Additionally, the taxonomy data may identify, for each term or word, related terms or words (e.g., “The Big Apple” may be related to “New York City” or “creamy custard desserts” may be related to “Crème Brulé”). In some instances, the related terms or words may synonyms of a word or term (e.g., “poorly lit” may be related to “gloomy”). In other instances, the related terms or words may be variations of spellings of a word (e.g., “Baris,” “Pris,” “Oris” and “[aris” may be variations of the spelling of “Paris”). In such examples, executed search engine 502 may initially utilize query 506 as originally submitted to search computing system 500 to search for one or more related content items. In examples where executed search engine 502 is unable to find content items related to query 506, executed search engine 502 may utilize the taxonomy data to identify one or more terms or words related to query 506 (e.g., terms or words originally included in query 506). Additionally, executed search engine 502 may search for one or more related content items based on the one or more related terms or words.

By way of example, query 506 may include the term or phrase “Colleague Movies.” Additionally, executed search engine 502 may search for related content items based on query 506. In examples where executed search engine 502 is unable to find content items related to query 506, executed search engine 502 may access taxonomy database 504 to obtain and utilize the taxonomy data to identify one or more related terms or words, such as “College Movies.” Further, executed search engine 502 may search for one or more related content items based on the one or more related terms or words (e.g., “College Movies”).

In some examples, executed search engine 502 may utilize account data of users 132 to personalize search results 508 associated with queries, such as query 506, provided by users 132. As described herein, the account data for each user 132, may identify a history of content items corresponding user 132 has consumed (e.g., viewed, listened to, and/or played). Additionally, the account data may identify one or more classifications associated with each content item, such as genre (e.g., documentary, horror, thriller, drama, action, comedy, historical, animation, fantasy, etc.). Moreover, account data may indicate which classifications corresponding user 132 may be more interested in. In such examples, executed search engine 502 may determine, for each user 132, one or more classifications user 132 may more likely consume or may be more interested in (e.g., horror versus documentary). For instance, executed search engine 502 may determine, for each user 132 and for each classification, the number of times corresponding user 132 has consumed associated content items, based on corresponding account data. Additionally, executed search engine 502 may determine whether the number of times is greater than or equal to a predetermined threshold value. Based on such determinations, executed search engine 502 may determine, for each user 132, which classification user 132 is more likely to consume or be more interested in. Further, executed search engine 502 may personalize search results 508 for each user 132, based on which classification executed search engine 502 has determined user 132 is more likely to consume or be more interested in. In some instances, executed search engine 502 may organize the content items identified in search results 508 so that content items of classifications that are determined more likely user 132 consumes or is interested in, is presented first. In other instances, executed search engine 502 may remove content items identified in search results 508 that are associated with classifications that user 132 is determined to not likely consume or be interested in.

For example, search results 508, may include a first content item associated with the comedy genre and a second content item associated with the action genre. Additionally, executed search engine 502 may determine user 132 associated with search results 508 may more likely consume content items associated with the comedy genre, based on account data of user 132. Further, executed search engine 502 may organize the content items identified in search results 508 so that the first content item is presented first, or remove the second content item from search results 508 based on such determinations.

In other examples, media systems 104 may present information included in search results 508, such as the one or more identified content items. For instance, and referring to FIG. 1 and FIG. 5, display device(s) 108 may generate and present a graphical user interface (GUI) including information of the content items identified in search results 508. In some instances and based on the one or more classifications of each identified content item, the presentation of the information of the content items may be organized by classification. For instance, the GUI may present graphical representations of each identified content item and group them by similar classifications, such as genre. In other instances, the information presented by the GUI may include information related to portions or segments of the content item that are associated with query 506. For instance, for each identified content item, the GUI may present one or more graphical elements that each identify a segment or portion of the content item that includes one or more portions of a phrase or term included in query 506 (e.g., “Muriel Bing”). Further, and in some instances, a graphical element may be an interactive graphical element that when selected by user 132 (e.g., via one or more provided user inputs), may cause media system 104 to present, on display device(s) 108), the corresponding segment or portion of the content item. For instance, a graphical element may indicate that at timestamp 1:40 of a content item (e.g., content item 306) the phrase “Get to the Choppa” is mentioned. Additionally, based on one or more user inputs provided by user 132, the graphical element is selected. Further, based on the selection, media system 104 may cause display device(s) 108 to display content item, specifically, at timestamp 1:40 or at a predetermined time prior to the corresponding segment or portion of the content item (e.g., at timestamp 1:30).

In various examples, media system 104 may present all or a selection of the identified content items included in search results 508. In such examples, user 132 may provide an input that indicates whether all or a selection of the identified content items included in search results 508 is to be presented by media system 104. Additionally, media system 104 may present all or the selected content items of search results 508, based on the input of user 132. For example, media system 104 may receive search results 508 that may correspond to query 506 that includes the terms or phrase “sashay away.” Additionally, search results 508 may identify a first content item, a second content item and a third content item associated with the terms or phrase “sashay away.” Moreover, search results 508 may include information that identifies, for each of the first content item, the second content item and the third content item, one or more portions or segments that includes one or more portions of the phrase “sashay away.” Further, media systems 104 may receive an input from user 132 that indicates whether all or a selection of the identified content items of search results 508 is to be presented by media system 104.

In instances where the input indicates all of the identified content items of search results 508 is to be presented, media system 104 may cause display device(s) 108 to present each of the content items included in search results 508. In some instances, media system 104 may present each of the content items included in search results 508 (e.g., each of the first content item, the second content item and the third content item). In other instances, media system 104 may present the segments or portions associated with the phrase or term included in query 506 (e.g., “sashay away”) of each of the content items included in search results 508 (e.g., each of the first content item, the second content item and the third content item). In various instances, media system 104 may present the segments or portions of each of the content items or each of the content items, consecutively or randomly.

In instances where the input of user 132 indicates a selection of the identified content items of search results 508 is to be presented by media system 104, the input may further indicate or select which of the identified content items of the search results 508 is to be presented. For instance, and following the example above, the input may indicate or select the first content item and the third content item of search results 508 is to be presented by media system 104. Additionally, media system 104 may present the indicated or selected content items based on the input of user 132. In some instances, media system 104 may present each of the selected or indicated content items identified in search results 508 (e.g., the first content item and the third content item of search results 508). In other instances, media system 104 may present the segments or portions associated with the phrase or terms included in query 506 of each of the content items identified in search results 508 (e.g., segments or portions associated with the phrase or terms “sashay away” of each of the first content item, and the third content item. In various instances, media system 104 may present the segments or portions of each of the selected or indicated content items or each of the selected or indicated content items, consecutively or randomly.

In some instances, and as illustrated in FIG. 5, each of search computing system and portions of content server(s) 120, such as executed content engine 310 and content database 312, may correspond to a distributed system. In other instances, search computing system and portions of content server(s) 120, such as executed content engine 310 and content database 312, may be included in a single computing system. In various instances, the functionalities of search computing system and portions of content server(s) 120, such as executed content engine 310 and content database 312, as described herein, may be performed by a single, discrete computing system.

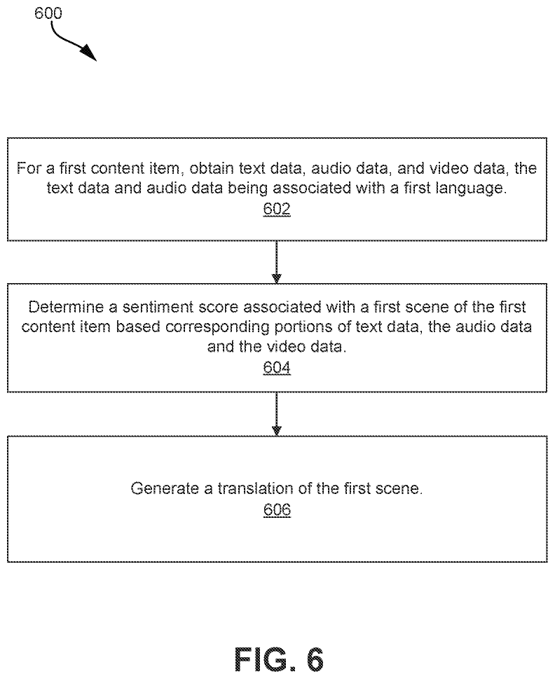

FIG. 6 is a flowchart for a method 600 for translating a content item utilizing sentiments of the content item, according to some examples of the present disclosure. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 3 and FIG. 4. However, method 600 is not limited to that example. Referring to FIG. 6, translation computing system 300 may, for a first content item, obtain text data, audio data, and video data (e.g., step 602 of FIG. 6). For example, executed sentiment engine 302 of translation computing system 300 may obtain, from content server 120, content item 306 including text data 307, audio data 308 and/or video data 309. As described herein, examples of content item 306 may include movies, television shows, podcasts, or any multimedia content.

Additionally, translation computing system 300 may determine a sentiment score associated with a first scene of the first content item based on corresponding portions of text data, the audio data and the video data (e.g., step 604 of FIG. 6). For example, executed sentiment engine 302 may determine a sentiment score associated with a first scene of the first content item based on corresponding portions of text data 307, audio data 308 and video data 309. As described herein, the sentiment score may correlate with a sentiment, such as a tone or emotion.

In some examples, executed sentiment engine 302 may determine a sentiment score associated with the first scene by applying one or more trained AI/ML processes to the corresponding portions of text data 307, audio data 308 and video data 309. For example, executed sentiment engine 302 may apply sentiment AI/ML process 404 to the corresponding portions of text data 307, audio data 308 and video data 309. Additionally, executed sentiment engine 302 may determine a sentiment value associated with each of the corresponding portions of text data 307, audio data 308 and video data 309. Further, sentiment AI/ML process 404 may determine sentiment score 406 for each scene or each dialogue line of each scene based on the sentiment values of the corresponding portion of text data 307, audio data 308 and/or video data 309.

In some instances, sentiment AI/ML process 404 may perform sentiment analysis on the corresponding portion of text data 307 to determine a sentiment value associated with the corresponding portion of text data 307. As described herein, the sentiment value of the corresponding portion of text data 307 (e.g., the combination of words included in the portion) may correlate with a sentiment, such as a tone or emotion, associated with the corresponding portion of text data 307. In other instances, sentiment AI/ML process 404 may perform sentiment analysis on the corresponding portion of audio data 308 to determine a sentiment value associated with the corresponding portion of audio data 308. As described herein, the sentiment value of the corresponding portion of audio data 308 (e.g., the combination of words included in the portion) may correlate with a sentiment, such as a tone or emotion, associated with the corresponding portion of audio data 308. In various instances, sentiment AI/ML process 404 may perform video analysis on the corresponding portion of video data 309 to determine a sentiment value associated with the corresponding portion of video data 309. As described herein, the sentiment value of the corresponding portion of video data 309 may correlate with a sentiment, such as a tone or emotion, associated with the corresponding portion of video data 309.

Referring to FIG. 6, translation computing system 300 may generate a translation of the first scene (e.g., step 606 of FIG. 6). In some examples, translation computing system 300 may generate a translation of the first scene utilizing the sentiment score of the first scene. Additionally, translation computing system 300 may utilize one or more trained AI/ML processes, such as translation AI/ML process 408, to translate the first scene utilizing the sentiment score of the first scene. For example, executed sentiment engine 302 may generate sentiment data 314 including the sentiment score of the first scene. Additionally, executed sentiment engine 302 may transmit sentiment data 314 to executed translation engine 304. In some instances, executed sentiment engine 302 may transmit or provide portions of content item 306, such as text data 307 and/or audio data 308 corresponding to the first scene. Moreover, executed translation engine 304 may generate a translation of the corresponding portions of text data 307 and/or audio data 308 utilizing sentiment data 314. Further, executed translation engine 304 may generate translation data 316 that includes the translation of the corresponding portions of text data 307 and/or audio data 308.

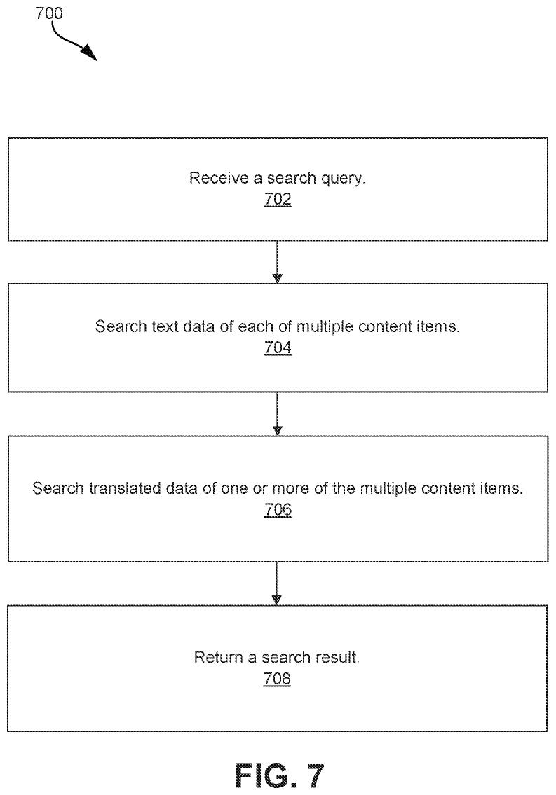

FIG. 7 is a flowchart for a method 700 for querying text data and translated text data of multiple content items. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIG. 5. However, method 700 is not limited to that example. Referring to FIG. 7, search computing system 500 may receive a search query (e.g., step 702 of FIG. 7). For example, executed search engine 502 of search computing system 500 may obtain query 506 from media systems 104. As described herein, query 506 may be based on one or more user inputs provided by user 132. Additionally, query 506 may include one or more terms, such as “let's go to Paris.”

Additionally, search computing system 500 may search text data of each of multiple content items (e.g., step 704 of FIG. 7). In some examples, search computing system 500 may access an index of multiple content items to identify one or more content items related to a user submitted query. As described herein, the index may be based on text data (e.g., closed captioning or subtitles) and/or translated text data of the multiple content items. In some instances, the index may include portions of text data and/or translated text data of the multiple content items. For example, executed search engine 502 may access content database 312 and search the index, via executed content engine 310. Moreover, executed search engine 502 may determine whether one or more content items are related to query 506 based on query 506 and the text data or translated text data of the multiple content items. Further, executed search engine 502 may generate search results 508 identifying content items that are related to query 506.

Moreover, search computing system 500 may return search results (e.g., step 706 of FIG. 7). In some examples, search results 508 may identify, for each identified content item, one or more classifications, such as genre (e.g., documentary, horror, thriller, drama, action, comedy, historical, animation, fantasy, etc.), type of media, etc. In such examples, executed search engine 502 may access content database 312, via content engine 310, to obtain, for each identified content item, data identifying the associated classifications. Further, executed search engine 502 may include such data into search results 508. Additionally, or alternatively, search results 508 may identify, for each identified content item, portions or segments of the content item that are associated with query 506, such as the terms, phrases or words included in query 506.

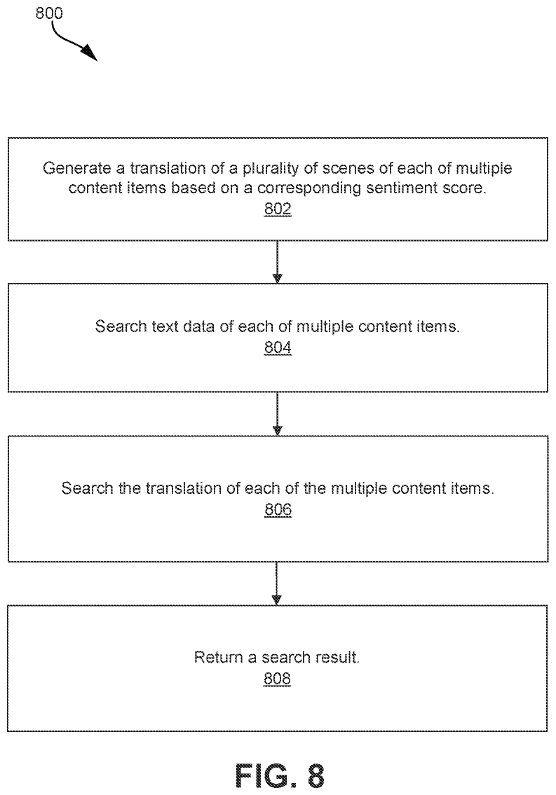

FIG. 8 is a flowchart for a method 800 for translating text data of multiple content items utilizing sentiments of the multiple content items and querying the translated text data and text data of each of the multiple content items. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIG. 3, FIG. 4 and/or FIG. 5. However, method 800 is not limited to that example. Referring to FIG. 8, translation computing system 300 may generate a translation of each of multiple content items based on corresponding sentiment scores (e.g., step 802 of FIG. 8). For example, executed sentiment engine 302 of translation computing system 300 may obtain, from content server 120, multiple content items, such as content item 306. Additionally, each of the multiple content items may include text data, audio data and/or video data, such as text data 307, audio data 308 and/or video data 309. As described herein, examples of each of the multiple content items may include movies, television shows, podcasts, or any multimedia content. Moreover, executed sentiment engine 302 of translation computing system 300 may perform any of the example processes as describe herein to generate, for each of the multiple content items, a sentiment score for each scene or each dialogue line of each scene, based on corresponding portions of text data, audio data and/or video data. In some instances, executed sentiment engine 302 may utilize one or more trained AI/ML processes to generate the sentiment scores, such as sentiment AI/ML process 404. Further, executed translation engine 304 may perform any of the example processes as describe herein to generate, for each of the multiple content items, a translation of each scene or each dialogue line of each scene based on the sentiment scores. In some instances, executed translation engine 304 may utilize one or more trained AI/ML processes to generate the translations, such as translation AI/ML process 408. In some instances, executed translation engine 304 may generate translation data 316 that includes the generated translations and provide translation data 316 to content server(s) 120. In such instances, executed content engine 310 may store the translations included in translation data 316 into content database 312.

Additionally, search computing system 500 may receive a search query (e.g., step 804 of FIG. 8). For example, executed search engine 502 of search computing system 500 may obtain query 506 from media systems 104. As described herein, query 506 may be based on one or more user inputs provided by user 132. Additionally, query 506 may include one or more terms, such as “Muriel Bing.”

Moreover, search computing system 500 may search translation data of each of the multiple content items (e.g., step 806 of FIG. 8). In some examples, search computing system 500 may access an index of multiple content items to identify one or more content items related to a user submitted query. As described herein, the index may be based on text data (e.g., closed captioning or subtitles) and/or translated text data of the multiple content items. In some instances, the index may include portions of text data and/or translated text data of the multiple content items. For example, executed search engine 502 may access content database 312 and search the index, via executed content engine 310. Moreover, executed search engine 502 may determine whether one or more content items are related to query 506 based on query 506 and the text data or translated text data of the multiple content items. Further, executed search engine 502 may generate search results 508 identifying content items that are related to query 506.

Further, search computing system 500 may return search results (e.g., step 808 of FIG. 8). In some examples, search results 508 may identify, for each identified content item, one or more classifications, such as genre (e.g., documentary, horror, thriller, drama, action, comedy, historical, animation, fantasy, etc.), type of media, etc. In such examples, executed search engine 502 may access content database 312, via content engine 310, to obtain, for each identified content item, data identifying the associated classifications. Further, executed search engine 502 may include such data into search results 508. Additionally, or alternatively, search results 508 may identify, for each identified content item, portions or segments of the content item that are associated with query 506, such as the terms, phrases or words included in query 506.

### Example Neural Network Architectures

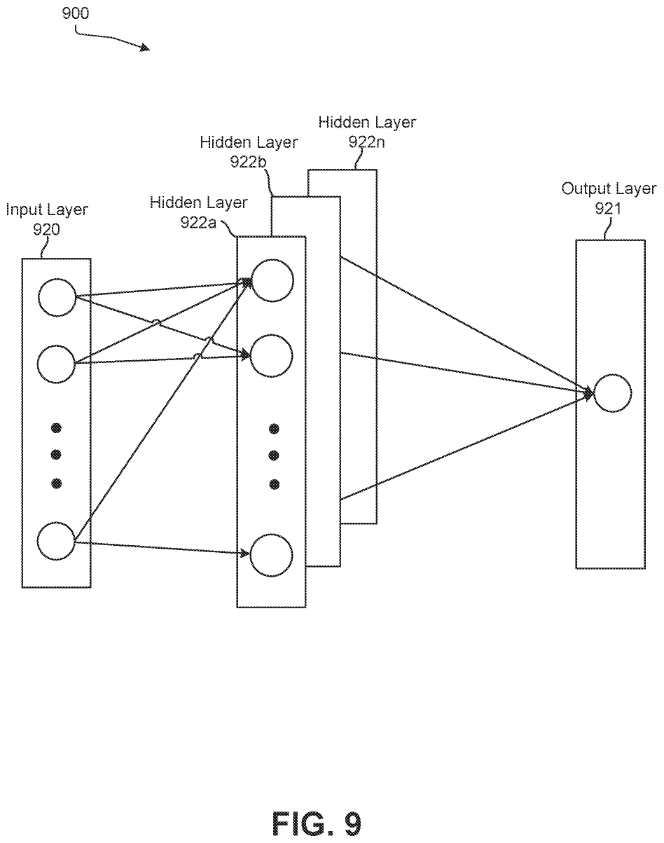

FIG. 9 is a diagram illustrating an example of a neural network architecture 900 that can be used to implement some or all of the neural networks described herein. The neural network architecture 900 can include an input layer 920 can be configured to receive and process data to generate one or more outputs. The neural network architecture 900 also includes hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network architecture 900 further includes an output layer 921 that provides an output resulting from the processing performed by the hidden layers 922a, 922b, through 922n.

The neural network architecture 900 is a multi-layer neural network of interconnected nodes. Each node can represent a piece of information. Information associated with the nodes is shared among the different layers and each layer retains information as information is processed. In some cases, the neural network architecture 900 can include a feed-forward network, in which case there are no feedback connections where outputs of the network are fed back into itself. In some cases, the neural network architecture 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 921, at which an output is provided. In some cases, while nodes in the neural network architecture 900 are shown as having multiple output lines, a node can have a single output and all lines shown as being output from a node represent the same output value.

In some cases, each node or interconnection between nodes can have a weight that is a set of parameters derived from the training of the neural network architecture 900. Once the neural network architecture 900 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 900 to be adaptive to inputs and able to learn as more and more data is processed.

The neural network architecture 900 is pre-trained to process the features from the data in the input layer 920 using the different hidden layers 922a, 922b, through 922n in order to provide the output through the output layer 921.

In some cases, the neural network architecture 900 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 900 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 900 can perform a backward pass by determining which inputs (weights) most contributed to the loss of the network and can adjust the weights so that the loss decreases and is eventually minimized.

The neural network architecture 900 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 900 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

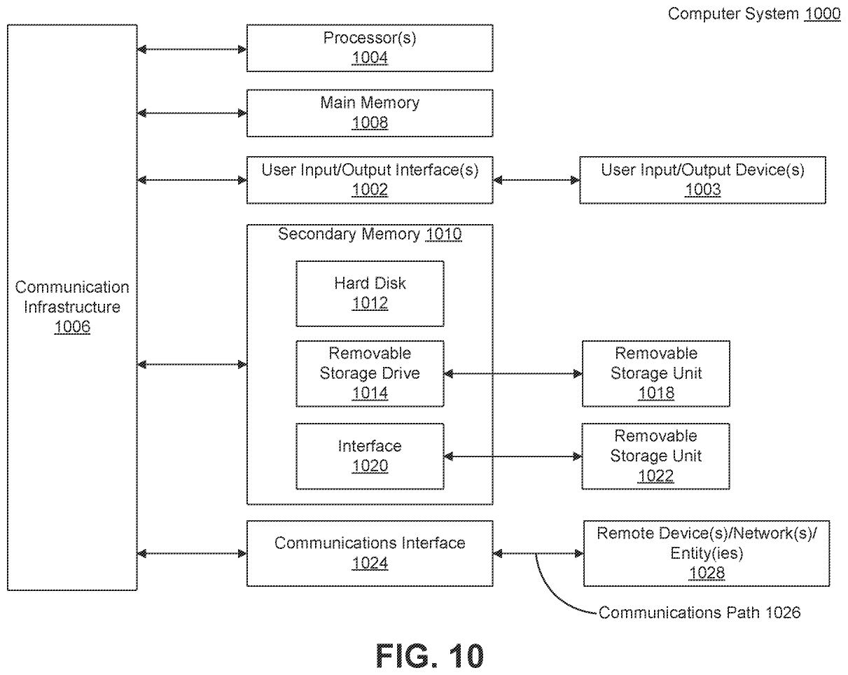

Various aspects and examples may be implemented, for example, using one or more well-known computer systems, such as computer system 1000 shown in FIG. 10. For example, the media device 106 may be implemented using combinations or sub-combinations of computer system 1000. Also, or alternatively, one or more computer systems 1000 may be used, for example, to implement any of the aspects and examples discussed herein, as well as combinations and sub-combinations thereof.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (e.g., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1000 may include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system xx00 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000 or processor(s) 1004), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein. It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases do not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A computing system comprising: a communications interface; a memory storing instructions; and at least one processor coupled to the communications interface and to the memory, the at least one processor being configured to execute the instructions to: for a first content item, obtain text data, audio data, and video data, the text data and audio data being associated with a first language; determine a sentiment score associated with a first scene of the first content item based corresponding portions of text data, the audio data and the video data; and generate a translation of the first scene based on the sentiment score, the translation being associated with a second language.

Aspect 2. The computing system of Aspect 1, wherein to determine the sentiment score, the at least one processor is further configured to: determine the sentiment score by applying a machine learning process to portions of text data, portions of audio data, and portions of video data associated with the first scene.

Aspect 3. The computing system of Aspects 1 or 2, wherein the sentiment score is based on a sentiment value associated with the portion of audio data corresponding to the first scene.

Aspect 4. The computing system of Aspects 1 to 3, wherein the sentiment score is based on a sentiment value associated with the portion of text data corresponding to the first scene.

Aspect 5. The computing system of Aspects 1 to 4, wherein to generate the translation of the first scene, the at least one processor is further configured to: generate the translation of the first scene by applying a machine learning process to the sentiment score and the text data.

Aspect 6. The computing system of Aspects 1 to 5, wherein the translation of the first scene is translated text data associated with the second language.

Aspect 7. The computing system of Aspects 1 to 6, wherein the translation of the first scene is translated audio data associated with the second language.

Aspect 8. The computing system of Aspects 1 to 7, wherein a portion of the audio data is associated with music associated with the first scene.

Aspect 9. The computing system of Aspects 1 to 8, wherein the audio data is associated with dialogue associated with the first scene.

Aspect 10. The computing system of Aspects 1 to 9, wherein the at least one processor is further configured to: receive a search query; search the text data; search the translated data; and return a search result.

Aspect 11. A computer-implemented method comprising: for a first content item, obtaining text data, audio data, and video data, the text data and audio data being associated with a first language; determining a sentiment score associated with a first scene of the first content item based corresponding portions of text data, the audio data and the video data; and generating a translation of the first scene based on the sentiment score, the translation being associated with a second language.

Aspect 12. The computer-implemented method of Aspect 11, wherein determining the sentiment score includes: determining the sentiment score by applying a machine learning process to portions of text data, portions of audio data, and portions of video data associated with the first scene.

Aspect 13. The computer-implemented method of Aspects 11 or 12, wherein the sentiment score is based on a sentiment value associated with the portion of audio data corresponding to the first scene.

Aspect 14. The computer-implemented method of Aspects 11 to 13, wherein the sentiment score is based on a sentiment value associated with the portion of text data corresponding to the first scene.

Aspect 15. The computer-implemented method of Aspects 11 to 14, wherein the translation of the first scene is translated text data associated with the second language.

Aspect 16. The computer-implemented method of Aspects 11 to 15, wherein the translation of the first scene is translated audio data associated with the second language.

Aspect 17. The computer-implemented method of Aspects 11 to 16, wherein a portion of the audio data is associated with music associated with the first scene.

Aspect 18. The computer-implemented method of Aspects 11 to 17, wherein the audio data is associated with dialogue associated with the first scene.

Aspect 19. The computer-implemented method of Aspects 11 to 18, further comprising: receiving a search query; searching the text data; searching the translated data; and returning a search result.

Aspect 20. A tangible, non-transitory computer readable medium storing instructions that, when executed by at least one processor, cause the at least one processor to perform operations comprising: for a first content item, obtaining text data, audio data, and video data, the text data and audio data being associated with a first language; determining a sentiment score associated with a first scene of the first content item based corresponding portions of text data, the audio data and the video data; and generating a translation of the first scene based on the sentiment score, the translation being associated with a second language.

Aspect 21. The tangible, non-transitory computer readable medium of Aspect 20, wherein determining the sentiment score includes: determining the sentiment score by applying a machine learning process to portions of text data, portions of audio data, and portions of video data associated with the first scene.

Aspect 22. The tangible, non-transitory computer readable medium of Aspects 20 or 21, wherein the sentiment score is based on a sentiment value associated with the portion of audio data corresponding to the first scene.

Aspect 23. The tangible, non-transitory computer readable medium of Aspects 20 to 22, wherein the sentiment score is based on a sentiment value associated with the portion of text data corresponding to the first scene.

Aspect 24. The tangible, non-transitory computer readable medium of Aspects 20 to 23, wherein the translation of the first scene is translated text data associated with the second language.

Aspect 25. The tangible, non-transitory computer readable medium of Aspects 20 to 24, wherein the translation of the first scene is translated audio data associated with the second language.

Aspect 26. The tangible, non-transitory computer readable medium of Aspects 20 to 25, wherein a portion of the audio data is associated with music associated with the first scene.

Aspect 27. The tangible, non-transitory computer readable medium of Aspects 20 to 26, wherein the audio data is associated with dialogue associated with the first scene.

Aspect 28. The tangible, non-transitory computer readable medium of Aspects 20 to 27, wherein the at least one processor further performs operations comprising: receiving a search query; searching the text data; searching the translated data; and returning a search result.

What is claimed is:

1. A computing system comprising:
a communications interface;
a memory storing instructions; and
at least one processor coupled to the communications interface and to the memory, the at least one processor being configured to execute the instructions to:
for a first content item, obtain text data, audio data, and video data, the text data and audio data being associated with a first language;
determine a sentiment score associated with a first scene of the first content item based corresponding portions of text data, the audio data and the video data; and
generate a translation of the first scene based on the sentiment score, the translation being associated with a second language.

2. The computing system of claim 1, wherein to determine the sentiment score, the at least one processor is further configured to:
determine the sentiment score by applying a machine learning process to portions of text data, portions of audio data, and portions of video data associated with the first scene.

3. The computing system of claim 1, wherein the sentiment score is based on a sentiment value associated with the portion of audio data corresponding to the first scene.

4. The computing system of claim 1, wherein the sentiment score is based on a sentiment value associated with the portion of text data corresponding to the first scene.

5. The computing system of claim 1, wherein to generate the translation of the first scene, the at least one processor is further configured to:
generate the translation of the first scene by applying a machine learning process to the sentiment score and the text data.

6. The computing system of claim 1, wherein the translation of the first scene is translated text data associated with the second language.

7. The computing system of claim 1, wherein the translation of the first scene is translated audio data associated with the second language.

8. The computing system of claim 1, wherein a portion of the audio data is associated with music associated with the first scene.

9. The computing system of claim 1, wherein the audio data is associated with dialogue associated with the first scene.

10. The computing system of claim 1, wherein the at least one processor is further configured to:
receive a search query;
search the text data;
search the translated data; and
return a search result.

11. A computer-implemented method comprising:
for a first content item, obtaining text data, audio data, and video data, the text data and audio data being associated with a first language;
determining a sentiment score associated with a first scene of the first content item based corresponding portions of text data, the audio data and the video data; and
generating a translation of the first scene based on the sentiment score, the translation being associated with a second language.

12. The computer-implemented method of claim 11, wherein determining the sentiment score includes:
determining the sentiment score by applying a machine learning process to portions of text data, portions of audio data, and portions of video data associated with the first scene.

13. The computer-implemented method of claim 11, wherein the sentiment score is based on a sentiment value associated with the portion of audio data corresponding to the first scene.

14. The computer-implemented method of claim 11, wherein the sentiment score is based on a sentiment value associated with the portion of text data corresponding to the first scene.

15. The computer-implemented method of claim 11, wherein the translation of the first scene is translated text data associated with the second language.

16. The computer-implemented method of claim 11, wherein the translation of the first scene is translated audio data associated with the second language.

17. The computer-implemented method of claim 11, wherein a portion of the audio data is associated with music associated with the first scene.

18. The computer-implemented method of claim 11, wherein the audio data is associated with dialogue associated with the first scene.

19. The computer-implemented method of claim 11, further comprising:
receiving a search query;
searching the text data;
searching the translated data; and
returning a search result.

20. A tangible, non-transitory computer readable medium storing instructions that, when executed by at least one processor, cause the at least one processor to perform operations comprising:
for a first content item, obtaining text data, audio data, and video data, the text data and audio data being associated with a first language;
determining a sentiment score associated with a first scene of the first content item based corresponding portions of text data, the audio data and the video data; and
generating a translation of the first scene based on the sentiment score, the translation being associated with a second language.
